(19) United States
(12) Patent Application Publication
(10) Pub. No.: US 2024/0264970 A1
(43) Pub. Date: Aug. 8, 2024

(54) REMOTE MEMORY BRIDGE AND METHOD FOR OPERATION

(71) Applicant: Lemon Inc., Grand Cayman, KY (US)

(72) Inventors: Ping Zhou, Los Angeles, CA (US); Kan Frankie Fan, Los Angeles, CA (US)

(21) Appl. No.: 18/640,868

(22) Filed: Apr. 19, 2024

(51) Int. Cl. G06F 13/42; G06F 13/40

(52) U.S. Cl. CPC G06F 13/4221; G06F 13/4068; G06F 2213/0026

(57) ABSTRACT

Described are examples of a remote memory bridge, or a method for providing or operating a remote memory bridge, that may include a host interface configured to access one or more memories of a host device, and a remote interface configured to provide, to one or more remote devices, a remote memory device function to access the one or more memories of the host device.

### BACKGROUND

The described aspects relate to data centers having many communicatively coupled servers, and more particularly, remote memory access among the servers.

Data center workloads can involve many servers, such as infrastructure as a service (IAAS), serverless, machine learning, and/or data analytics workloads. There can often be imbalanced memory usage between servers. For example, some servers may run out of memory, which may require migration of some workloads, while some other servers may have much of their memory unused. Sharing existing memory resources among servers can result in significant benefits. Currently, however, memory resources are largely isolated on each server, meaning that even if a server has free memory, it cannot easily share or lease some of its memory to other servers that are in need of more memory. In general, if a server wants to access memory on another server, there are several possible ways, including traditional message passing (e.g., using transmission control protocol (TCP) or other messages), or remote direct memory access (RDMA), both of which may require source code modification for applications desiring remote memory access.

New memory fabric technologies have been proposed, including compute express link (CXL), which provides native memory semantics (such as load and store instructions) for accessing remote memory, and is seamless to existing software applications. In CXL, a CXL host and CXL device are configured, where a server CPU can only act as a CXL host that accesses dedicated CXL memory devices (e.g. using CXL memory expander cards). In addition, CXL requires specific CPU support.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In an example, a remote memory bridge is provided that includes a host interface configured to access one or more memories of a host device, and a remote interface configured to provide, to one or more remote devices, a remote memory device function to access the one or more memories of the host device.

In another example, a method for providing a remote memory device function is provided that includes receiving, by a remote interface of a remote memory bridge, a request from a remote device to access one or more memories of a host device, and accessing, by a host interface and based on the request, the one or more memories of the host device.

In another example, one or more non-transitory computer-readable storage media are provided that store instructions that when executed by one or more processors cause the one or more processors to execute a method for providing a remote memory device function. The method includes receiving, by a remote interface of a remote memory bridge, a request from a remote device to access one or more memories of a host device, and accessing, by a host interface and based on the request, the one or more memories of the host device.

To the accomplishment of the foregoing and related ends, the one or more implementations comprise the features hereinafter fully described and particularly pointed out in the claims. The following description and the annexed drawings set forth in detail certain illustrative features of the one or more implementations. These features are indicative, however, of but a few of the various ways in which the principles of various implementations may be employed, and this description is intended to include all such implementations and their equivalents.

### BRIEF DESCRIPTION OF THE DRAWINGS

FIG. 1 is a schematic diagram of an example of systems including a remote memory bridge, in accordance with aspects described herein.

FIG. 2 is a schematic diagram of an example of a system including multiple hosts that can share memory via a remote memory bridge and a remote memory switch, and may be configured as remote memory hosts, in accordance with aspects described herein.

FIG. 3 is a schematic diagram of an example of a system including multiple hosts that can share memory via a remote memory bridge, and may be configured as remote memory hosts, in accordance with aspects described herein.

FIG. 4 is a schematic diagram of an example of a system including multiple hosts that can share memory via a remote memory bridge and a remote memory switch, where the remote memory bridges can be configured as remote memory hosts, in accordance with aspects described herein.

FIG. 5 is a schematic diagram of an example of a system including multiple hosts that can share memory via a remote memory bridge, where the remote memory bridges may be configured as remote memory hosts, in accordance with aspects described herein.

FIG. 6 is a flowchart of an example of a method for providing remote memory bridge functionality, in accordance with aspects described herein.

FIG. 7 is a schematic diagram of an example of a device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to providing a remote memory bridge and/or a method for operating a remote memory bridge. The remote memory bridge can include a host interface configured to communicate with a host device to access one or more memories of the host device, and a remote interface configured to communicate with one or more remote devices to provide, to the one or more remote devices, remote memory access to the one or more memories of the host device. For example, the remote memory bridge can be a peripheral component interconnect express (PCIe) device that can be communicatively coupled with the host device via a PCIe interface on the host device. In addition, for example, the remote memory bridge can be communicatively coupled with the one or more remote devices via a PCIe connection (e.g., a direct PCIe connection), via a network connection (e.g., using one or more network switches or other devices between the remote memory bridge and the one or more remote devices), and/or the like. This can allow for a remote memory device function to be provided at the host device to allow the remote devices to access memory of the host device.

In another example, the remote memory bridge may also provide a remote memory host function at the host device (e.g., where the host device is not otherwise configured with the remote memory host function). In this example, the remote memory bridge may include a memory host interface configured to access one or more remote memory devices. For example, the memory host interface can expose, to the host device, a base address register (BAR) space to allow the host device to access the one or more remote memory devices via the memory host interface using native memory semantics (e.g., load and/or store commands) referencing the BAR space. In accordance with aspects described herein, the remote memory bridge can facilitate remote memory access and sharing by various servers using native memory semantics, which can include support for servers having CPUs that may not support remote memory host functionality.

Aspects described herein can achieve seamless memory sharing/pooling between servers with lower cost and better compatibility than current remote memory access technologies. For example, state-of-the-art memory fabric technologies, such as compute express link (CXL), may be leveraged for performance and future compatibility. In addition, for example, compatibility can be provided with many server central processing units (CPUs) (including those without CXL capability), thus not requiring special CPU support. Moreover, for example, existing memory resources (e.g., memories on current servers) can be used instead of requiring extra memory devices. In some examples, the remote memory bridge can be provided as a two-sided PCIe device. On a host side, the remote memory bridge can present itself as an ordinary PCIe device and can access a host CPU's memory. Externally, the remote memory bridge can act as a remote memory device (e.g. a CXL Type3 Device) that can be accessed by other hosts. In an example, if the host CPU does not have the capability of a remote memory host (e.g., older models), the remote memory bridge can also act as a remote memory host on behalf of the host CPU. In this case, for example, the remote memory bridge can expose PCIe base address register (BAR) space to the host CPU, so that host CPU can read and/or write to this address space to access the remote memory.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

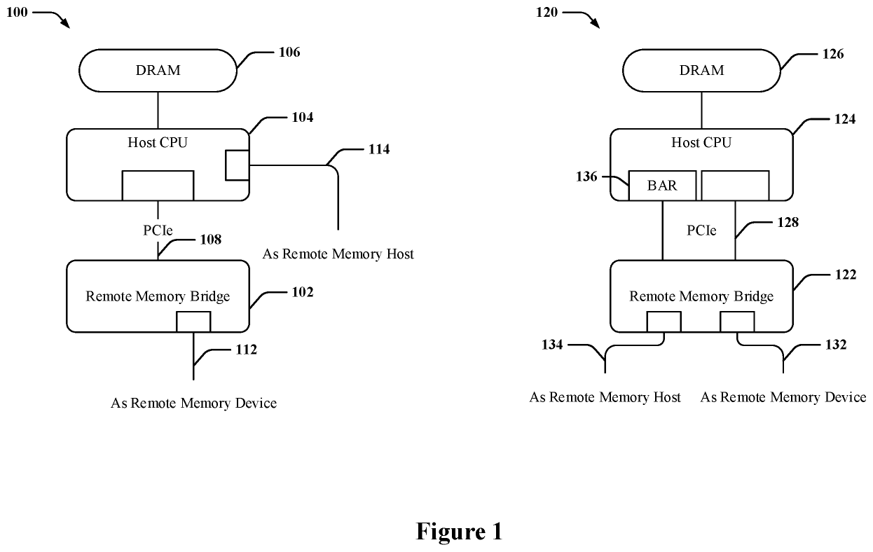

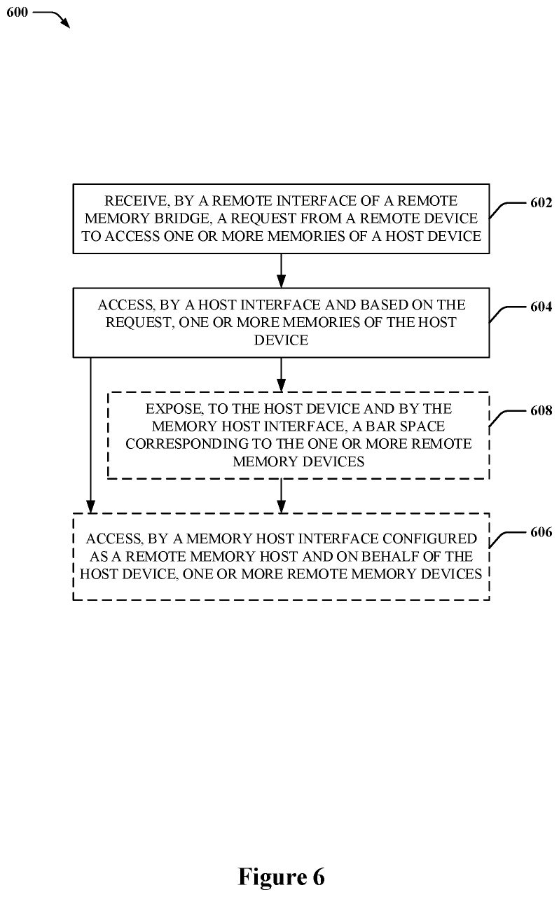

Turning now to FIGS. 1-7, examples are depicted with reference to one or more components and one or more methods that may perform the actions or operations described herein, where components and/or actions/operations in dashed line may be optional. Although the operations described below in FIG. 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of systems including a remote memory bridge, in accordance with aspects described herein. System 100 includes a remote memory bridge 102 that can be communicatively coupled with a host CPU 104 for accessing a memory thereof, such as dynamic random access memory (DRAM) 106. In an example, remote memory bridge 102 can be communicatively coupled with the host CPU 104 via host interface, such as a PCIe interface 108, or other interface, which may facilitate access of the DRAM 106. In addition, the remote memory bridge 102 can include a remote interface 112 for providing a remote memory device. The remote interface 112 can allow one or more remote devices to connect with the remote memory bridge 102 as a remote memory device to access the DRAM 106 of the host CPU 104. In an example, the remote memory device provided via the remote interface 112 can include a CXL Type3 device, such that the remote devices can use native memory semantics to access, via the remote memory bridge 102, the DRAM 106 of the host CPU 104. In addition, in system 100, the host CPU 104 can include a memory host interface 114 that provides a remote memory host to remotely access one or more memories of one or more other remote memory devices. For example, host CPU 104 may have CXL functionality to provide the memory host interface 114.

System 120 includes a remote memory bridge 122 that can be communicatively coupled with a host CPU 124 for accessing a memory thereof, such as DRAM 126. In an example, remote memory bridge 122 can be communicatively coupled with the host CPU 124 via host interface, such as a PCIe interface 128, or other interface, which may facilitate access of the DRAM 126. In addition, the remote memory bridge 122 can include a remote interface 132 for providing a remote memory device. The remote interface 132 can allow one or more remote devices to connect with the remote memory bridge 122 as a remote memory device to access the DRAM 126 of the host CPU 124. In an example, the remote memory device provided via the remote interface 132 can include a CXL Type3 device, such that the remote devices can use native memory semantics to access, via the remote memory bridge 122, the DRAM 126 of the host CPU 124.

In addition, in system 120, the host CPU 124 may not include a host memory interface as does the host CPU 104 in system 100. In this regard, for example, the remote memory bridge 122 can include a memory host interface 134 that provides a remote memory host to remotely access one or more memories of one or more other remote memory devices. For example, the remote memory bridge 122 can communicate with the host CPU 124, via the PCIe interface 128, to receive commands to remotely access the one or more memories of the one or more remote memory devices. For example, remote memory bridge 122 can expose BAR space 136 to the host CPU 124 via the PCIe interface 128. In this example, the host CPU 124 can use native memory semantics (e.g., load or store commands) in the BAR space 136 to access the one or more memories of the one or more remote memory devices via the remote memory bridge 122. In one example, the remote memory bridge 122 can provide the remote memory host as a CXL host that uses CXL functionality to access the one or more remote memory devices (e.g., dedicated CXL Type3 devices or other remote memory bridges of other host CPUs, etc.). Thus, in some examples, with the remote memory bridge, a server can act as both remote memory host and remote memory device at the same time. Therefore, the server may be able to access another server's memory, and can also share or lease its memory to other servers.

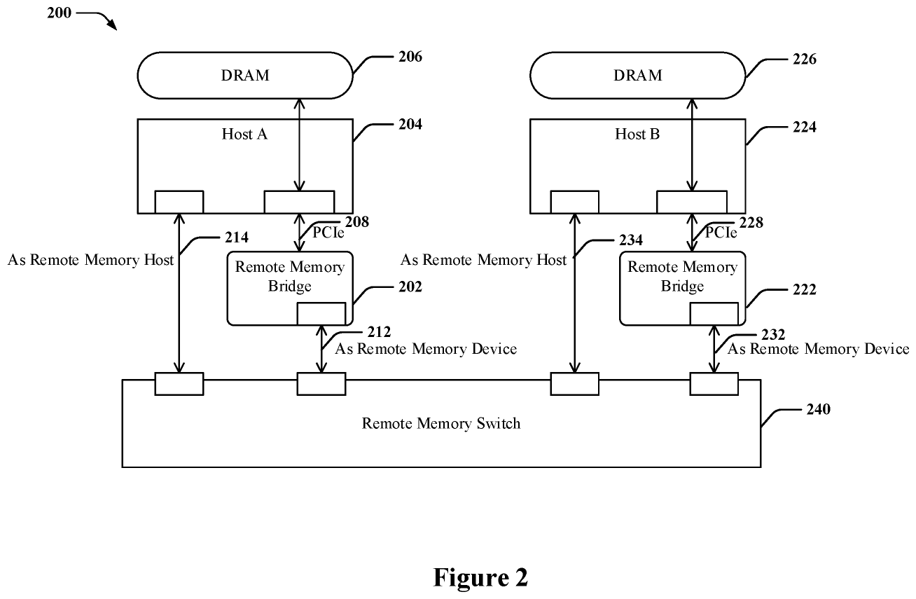

FIG. 2 is a schematic diagram of an example of a system 200 including multiple hosts that can share memory via a remote memory bridge and a remote memory switch, and may be configured as remote memory hosts, in accordance with aspects described herein. System 200 includes a remote memory bridge 202 that can be communicatively coupled with a host CPU, host A 204, for accessing a memory thereof, such as DRAM 206. In an example, remote memory bridge 202 can be communicatively coupled with the host A 204 via host interface, such as a PCIe interface 208, or other interface, which may facilitate access of the DRAM 206. In addition, the remote memory bridge 202 can include a remote interface 212 for providing a remote memory device. The remote interface 212 can allow one or more remote devices to connect with the remote memory bridge 202 as a remote memory device to access the DRAM 206 of the host A 204. In an example, the remote memory device provided via the remote interface 212 can include a CXL Type3 device, such that the remote devices can use native memory semantics to access, via the remote memory bridge 202, the DRAM 206 of the host A 204. In addition, in system 200, the host A 204 can include a memory host interface 214 that provides a remote memory host to remotely access one or more memories of one or more other remote memory devices. For example, host A 204 may have CXL functionality to provide the memory host interface 214.

System 200 also includes a remote memory bridge 222 that can be communicatively coupled with a host CPU, host B 224, for accessing a memory thereof, such as DRAM 226. In an example, remote memory bridge 222 can be communicatively coupled with the host B 224 via host interface, such as a PCIe interface 228, or other interface, which may facilitate access of the DRAM 226. In addition, the remote memory bridge 222 can include a remote interface 232 for providing a remote memory device. The remote interface 232 can allow one or more remote devices to connect with the remote memory bridge 222 as a remote memory device to access the DRAM 226 of the host B 224. In an example, the remote memory device provided via the remote interface 232 can include a CXL Type3 device, such that the remote devices can use native memory semantics to access, via the remote memory bridge 222, the DRAM 226 of the host B 224. In addition, in system 200, the host B 224 can include a memory host interface 234 that provides a remote memory host to remotely access one or more memories of one or more other remote memory devices. For example, host B 224 may also have CXL functionality to provide the memory host interface 234.

In an example, the remote memory bridges 202 and 222 can communicate over a remote memory switch 240 (e.g., a CXL switch), which can be provided over a network switch and/or other network devices, to route memory access requests among the remote memory bridges coupled to the remote memory switch. In an example, host A 204 can access memory of DRAM 226 of host B 224 (e.g., to lease memory therefrom for writing to and/or reading from) by using the memory host interface 214 of the host A 204 (e.g., a CXL host) to request memory via remote memory switch 240. The request for memory can be made to the remote memory device provided by the remote interface 232 of the remote memory bridge 222, which can access the DRAM 226 of host B 224 using the PCIe interface 228. For example, assuming host B 224 has leased some of its memory (e.g., in DRAM 226) to host A 204, then host A 204 can access these remote memories by initiating native memory access instructions (e.g., load/store) to the remote memory region. The memory access requests can traverse the remote memory switch 240 and reach the remote memory bridge 222 of host B 224. The remote memory bridge 222 translates the remote memory requests into PCIe transactions, and passes them to host B 224. In another example, assuming host A 204 has leased some of its memory (e.g., in DRAM 206) to host B 224, then host B 224 can access these remote memories by initiating native memory access instructions (e.g., load/store) to the remote memory region. The memory access requests can traverse the remote memory switch 240 and reach the remote memory bridge 202 of host A 204. The remote memory bridge 202 translates the remote memory requests into PCIe transactions, and passes them to host A 204.

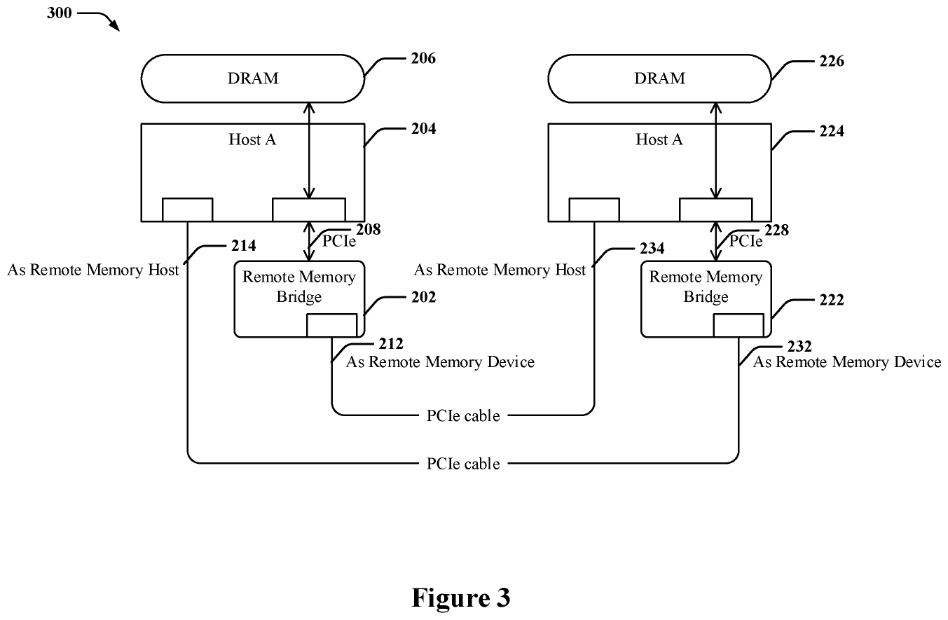

FIG. 3 is a schematic diagram of an example of a system 300 including multiple hosts that can share memory via a remote memory bridge, and may be configured as remote memory hosts, in accordance with aspects described herein. System 300 includes the components of system 200 described above, except for the remote memory switch 240. In system 300, the memory host interface 214 can be communicatively coupled with the remote interface 232 via PCIe cable to facilitate remote access to DRAM 226. Similarly, in system 300, the memory host interface 234 can be communicatively coupled with the remote interface 212 via PCIe cable to facilitate remote access to DRAM 206. In this regard, for example, the two servers can access each other's memory in a similar way as described for system 200, except without going through a remote memory switch.

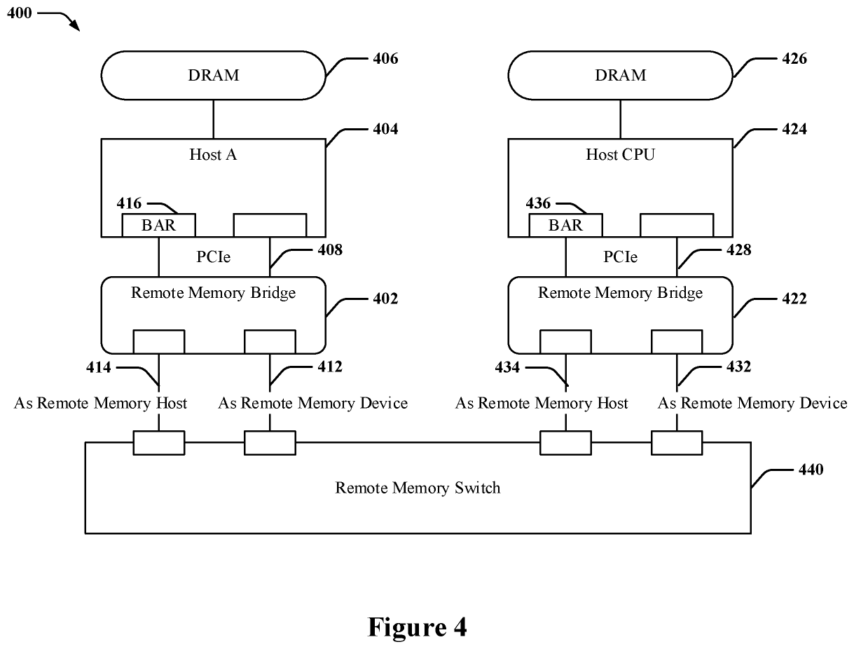

FIG. 4 is a schematic diagram of an example of a system 400 including multiple hosts that can share memory via a remote memory bridge and a remote memory switch, where the remote memory bridges can be configured as remote memory hosts, in accordance with aspects described herein. System 400 includes a remote memory bridge 402 that can be communicatively coupled with a host CPU, host A 404, for accessing a memory thereof, such as DRAM 406. In an example, remote memory bridge 402 can be communicatively coupled with the host A 404 via host interface, such as a PCIe interface 408, or other interface, which may facilitate access of the DRAM 406. In addition, the remote memory bridge 402 can include a remote interface 412 for providing a remote memory device. The remote interface 412 can allow one or more remote devices to connect with the remote memory bridge 402 as a remote memory device to access the DRAM 406 of the host A 404. In an example, the remote memory device provided via the remote interface 412 can include a CXL Type3 device, such that the remote devices can use native memory semantics to access, via the remote memory bridge 402, the DRAM 406 of the host A 404. In addition, for example, the remote memory bridge 402 can include a memory host interface 414 that provides a remote memory host to remotely access one or more memories of one or more other remote memory devices. For example, the remote memory bridge 402 can communicate with the host A 404, via the PCIe interface 408, to receive commands to remotely access the one or more memories of the one or more remote memory devices. For example, remote memory bridge 402 can expose BAR space 416 to the host A 404 via the PCIe interface 408. In this example, the host A 404 can use native memory semantics (e.g., load or store commands) in the BAR space 416 to access the one or more memories of the one or more remote memory devices via the remote memory bridge 402. In one example, the remote memory bridge 402 can provide the remote memory host as a CXL host that uses CXL functionality to access the one or more remote memory devices (e.g., dedicated CXL Type3 devices or other remote memory bridges of other host CPUs, etc.).

System 400 also includes a remote memory bridge 422 that can be communicatively coupled with a host CPU, host B 424, for accessing a memory thereof, such as DRAM 426. In an example, remote memory bridge 422 can be communicatively coupled with the host B 424 via host interface, such as a PCIe interface 428, or other interface, which may facilitate access of the DRAM 426. In addition, the remote memory bridge 422 can include a remote interface 432 for providing a remote memory device. The remote interface 432 can allow one or more remote devices to connect with the remote memory bridge 422 as a remote memory device to access the DRAM 426 of the host B 424. In an example, the remote memory device provided via the remote interface 432 can include a CXL Type3 device, such that the remote devices can use native memory semantics to access, via the remote memory bridge 422, the DRAM 426 of the host B 424. In addition, for example, the remote memory bridge 422 can include a memory host interface 434 that provides a remote memory host to remotely access one or more memories of one or more other remote memory devices. For example, the remote memory bridge 422 can communicate with the host B 424, via the PCIe interface 428, to receive commands to remotely access the one or more memories of the one or more remote memory devices. For example, remote memory bridge 422 can expose BAR space 436 to the host B 424 via the PCIe interface 428. In this example, the host B 424 can use native memory semantics (e.g., load or store commands) in the BAR space 436 to access the one or more memories of the one or more remote memory devices via the remote memory bridge 422. In one example, the remote memory bridge 422 can provide the remote memory host as a CXL host that uses CXL functionality to access the one or more remote memory devices (e.g., dedicated CXL Type3 devices or other remote memory bridges of other host CPUs, etc.).

In an example, the remote memory bridges 402 and 422 can communicate over a remote memory switch 440 (e.g., a CXL switch), which can be provided over a network switch and/or other network devices, to route memory access requests among the remote memory bridges coupled to the remote memory switch. In an example, host A 404 can access memory of DRAM 426 of host B 424 (e.g., to lease memory therefrom for writing to and/or reading from) by using the memory host interface 414 of the remote memory bridge 402 (e.g., a CXL host) to request memory via remote memory switch 440. The request for memory can be made to the remote memory device provided by the remote interface 432 of the remote memory bridge 422, which can access the DRAM 426 of host B 424 using the PCIe interface 428. For example, assuming host B 424 has leased some of its memory (e.g., in DRAM 426) to host A 404, then host A 404 can access these remote memories by initiating native memory access instructions (e.g., load/store) to the remote memory region. The memory access requests can traverse the remote memory switch 440 and reach the remote memory bridge 422 of host B 424. The remote memory bridge 422 translates the remote memory requests into PCIe transactions, and passes them to host B 424. In another example, assuming host A 404 has leased some of its memory (e.g., in DRAM 406) to host B 424, then host B 424 can access these remote memories by initiating native memory access instructions (e.g., load/store) to the remote memory region via memory host interface 434 of remote memory bridge 422. The memory access requests can traverse the remote memory switch 440 and reach the remote memory bridge 402 of host A 404. The remote memory bridge 402 translates the remote memory requests into PCIe transactions, and passes them to host A 404.

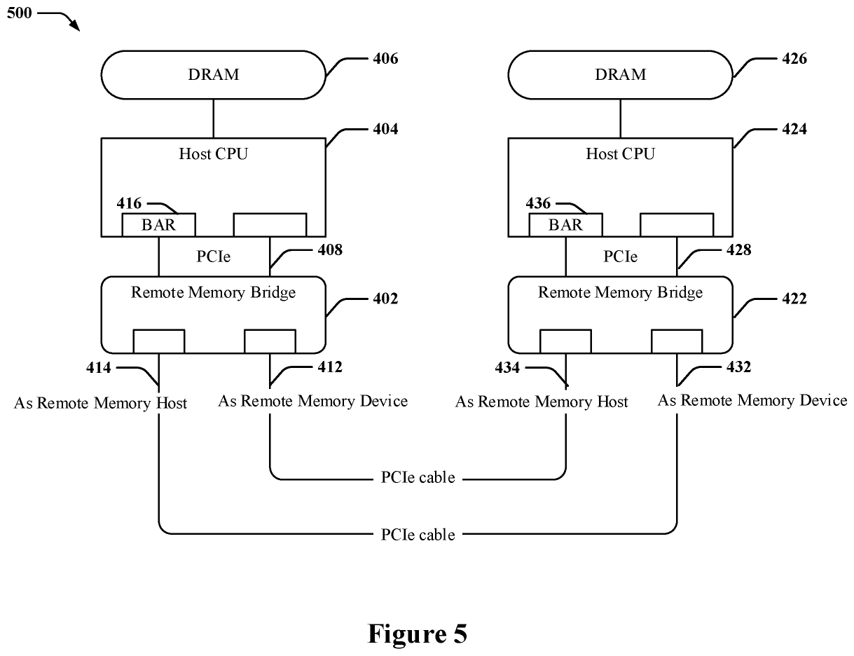

FIG. 5 is a schematic diagram of an example of a system 500 including multiple hosts that can share memory via a remote memory bridge, where the remote memory bridges may be configured as remote memory hosts, in accordance with aspects described herein. System 500 includes the components of system 400 described above, except for the remote memory switch 440. In system 500, the memory host interface 414 can be communicatively coupled with the remote interface 432 via PCIe cable to facilitate remote access to DRAM 426. Similarly, in system 500, the memory host interface 434 can be communicatively coupled with the remote interface 412 via PCIe cable to facilitate remote access to DRAM 406. In this regard, for example, the two servers can access each other's memory in a similar way as described for system 400, except without going through a remote memory switch.

In accordance with aspects described herein, a two-sided device design can be provided that allows the device to act as a bridge between host CPU and remote memories. In some aspects, a dual port design can also be provided on the remote memory bridge that acts as both remote memory host and remote memory device. This can allow operability with many types of servers without relying on any specific CPU support. In some aspects, the host CPU can access remote memories by accessing the PCIe BAR space of the remote memory bridge device, which acts as a remote memory host on behalf of the host CPU. Flexible configurations can support both small scale (direct connect) and larger scale (using switches), as described in various examples above.

FIG. 6 is a flowchart of an example of a method 600 for providing remote memory bridge functionality, in accordance with aspects described herein. For example, method 600 can be performed by a remote memory bridge 102, 122, 202, 222, 402, and/or 422, which may be coupled to a device or host CPU 104, 124, 204, 224, 404, 424, which may include, for example, a device 700 described herein that can be communicatively coupled to a remote memory bridge.

In method 600, at action 602, a request can be received, from a remote device, by a remote interface of a remote memory bridge, to access one or more memories of a host device. For example, remote memory bridge 102, 122, 202, 222, 402, and/or 422 can receive, by a remote interface 112, 132, 212, 232, 412, and/or 432 thereof, the request from the remote device (e.g., a different host CPU or device) to access one or more memories of the host device. For example, aa remote memory bridge of host A can receive the request from host B to access one or more memories (e.g., DRAM) of host A, as described above.

In method 600, at action 604, one or more memories of the host device can be accessed, by a host interface and based on the request. For example, remote memory bridge 102, 122, 202, 222, 402, and/or 422 can access, by a host interface 108, 128, 208, 228, 408, and/or 428, and based on the request, the one or more memories of the host device. For example, where host A receives the request, the host interface of host A can access the DRAM of host A based on the request from host B. As described, for example, accessing of the DRAM of host A may include loading data from the DRAM of host A for access by host B, storing data from host B in the DRAM of host A, etc., where the request can be a native memory access semantic. In this regard, the remote memory bridge can provide a remote memory device function (e.g., as a CXL Type3 device).

In method 600, optionally at action 606, one or more remote memory devices can be accessed by a memory host interface configured as a remote memory host and on behalf of the host device. In an example, remote memory bridge 102, 122, 202, 222, 402, and/or 422 can access, by a memory host interface 414, and/or 434 configured as a remote memory host and on behalf of the host device, one or more remote memory devices. For example, the memory host interface can access the one or more remote memory devices including remote memory bridges or other remote memory devices to access (e.g., load or store) values in the corresponding memory.

In method 600, optionally at action 608, a BAR space corresponding to the one or more remote memory devices can be exposed to the host device and by the memory host interface. In an example, remote memory bridge 102, 122, 202, 222, 402, and/or 422 can expose, to the host device and by the memory host interface 414 and/or 434, the BAR space 416 and/or 436 corresponding to the one or more remote memory devices (e.g., provided by remote memory bridge 402 and/or 422). In this regard, the host device can access the BAR space 416 and/or 436 using native memory access semantics to access (e.g., load and/or store values in) the memory of a different host device, as described herein.

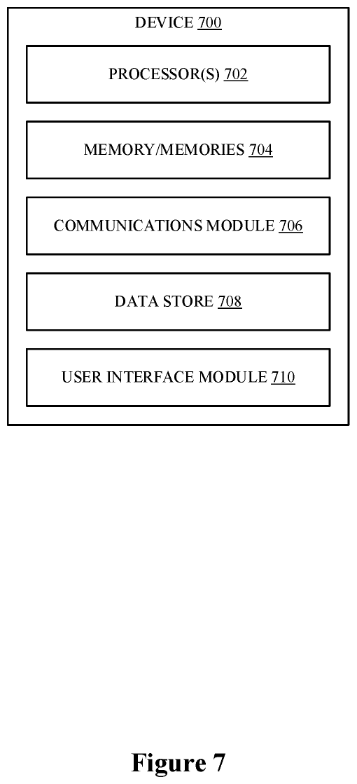

FIG. 7 illustrates an example of device 700, similar to or the same as a host CPU 104, 124, 204, 224, 404, and/or 424, including additional optional component details. In one implementation, device 700 may include processor(s) 702 for carrying out processing functions associated with one or more of components and functions described herein. Processor(s) 702 can include a single or multiple set of processors or multi-core processors. Moreover, processor(s) 702 can be implemented as an integrated processing system and/or a distributed processing system.

Device 700 may further include memory/memories 704, which may store local versions of applications being executed by processor(s) 702, related modules, instructions, parameters, etc. Memory/memories 704 can include a type of memory usable by a computer, such as random access memory (RAM), read only memory (ROM), tapes, magnetic discs, optical discs, volatile memory, non-volatile memory, and any combination thereof.

Further, device 700 may include a communications module 706 that provides for establishing and maintaining communications with one or more other devices, parties, entities, a remote memory bridge, etc., utilizing hardware, software, and services as described herein. Communications module 706 may carry communications between modules on device 700, as well as between device 700 and external devices, such as devices located across a communications network and/or devices serially or locally connected to device 700. For example, communications module 706 may include one or more buses, and may further include transmit chain modules and receive chain modules associated with a wireless or wired transmitter and receiver, respectively, operable for interfacing with external devices, and/or may include a PCIe or other connection or coupling interface.

Additionally, device 700 may include a data store 708, which can be any suitable combination of hardware and/or software, that provides for mass storage of information, databases, and programs employed in connection with implementations described herein. For example, data store 708 may be or may include a data repository for applications and/or related parameters being executed by, or not currently being executed by, processor(s) 702. In addition, data store 708 may be a data repository for instructions, parameters, etc., and/or one or more other modules of the device 700.

Device 700 may include a user interface module 710 operable to receive inputs from a user of device 700 and further operable to generate outputs for presentation to the user. User interface module 710 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface module 710 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more implementations, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various implementations described herein. Various modifications to these implementations will be readily apparent to those skilled in the art, and the generic principles defined herein may be applied to other implementations. Thus, the claims are not intended to be limited to the implementations shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various implementations described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A remote memory bridge, comprising:
a host interface configured to access one or more memories of a host device; and
a remote interface configured to provide, to one or more remote devices, a remote memory device function to access the one or more memories of the host device.

2. The remote memory bridge of claim 1, wherein the host interface is configured to access the one or more memories of the host device using a peripheral component interconnect express (PCIe) interface.

3. The remote memory bridge of claim 1, wherein the remote interface is configured to provide the remote memory device function as a compute express link (CXL) type 3 device.

4. The remote memory bridge of claim 1, wherein the remote interface is communicatively coupled with a remote memory host of the one or more remote devices using a peripheral component interconnect express (PCIe) interface.

5. The remote memory bridge of claim 1, wherein the remote interface is communicatively coupled with a remote memory host of the one or more remote devices using a network switch.

6. The remote memory bridge of claim 1, further comprising a memory host interface configured as a remote memory host to access, on behalf of the host device, one or more remote memory devices.

7. The remote memory bridge of claim 6, wherein the memory host interface is configured to expose, to the host device, a base address register (BAR) space corresponding to the one or more remote memory devices, and wherein the memory host interface is configured to access the one or more remote memory devices based on load or store requests in the BAR space.

8. A method for providing a remote memory device function, comprising:
receiving, by a remote interface of a remote memory bridge, a request from a remote device to access one or more memories of a host device; and
accessing, by a host interface and based on the request, the one or more memories of the host device.

9. The method of claim 8, wherein accessing the one or more memories of the host device is using a peripheral component interconnect express (PCIe) interface.

10. The method of claim 8, wherein providing the remote memory device function includes providing a compute express link (CXL) type 3 device.

11. The method of claim 8, wherein the host interface accesses a remote memory host of one or more remote devices using a peripheral component interconnect express (PCIe) interface.

12. The method of claim 8, wherein the host interface accesses a remote memory host of one or more remote devices using a network switch.

13. The method of claim 8, further comprising accessing, by a memory host interface configured as a remote memory host and on behalf of the host device, one or more remote memory devices.

14. The method of claim 13, further comprising exposing, to the host device and by the memory host interface, a base address register (BAR) space corresponding to the one or more remote memory devices, and wherein accessing, by the memory host interface, the one or more remote memory devices is based on load or store requests in the BAR space.

15. One or more non-transitory computer-readable storage media storing instructions that when executed by one or more processors cause the one or more processors to execute a method for providing a remote memory device function, wherein the method comprises:
receiving, by a remote interface of a remote memory bridge, a request from a remote device to access one or more memories of a host device; and
accessing, by a host interface and based on the request, the one or more memories of the host device.

16. The one or more non-transitory computer-readable storage media of claim 15, wherein accessing the one or more memories of the host device is using a peripheral component interconnect express (PCIe) interface.

17. The one or more non-transitory computer-readable storage media of claim 15, wherein providing the remote memory device function includes providing a compute express link (CXL) type 3 device.

18. The one or more non-transitory computer-readable storage media of claim 15, wherein the host interface accesses a remote memory host of one or more remote devices using a peripheral component interconnect express (PCIe) interface.

19. The one or more non-transitory computer-readable storage media of claim 15, wherein the host interface accesses a remote memory host of one or more remote devices using a network switch.

20. The one or more non-transitory computer-readable storage media of claim 15, the method further comprising accessing, by a memory host interface configured as a remote memory host and on behalf of the host device, one or more remote memory devices.
